(19) United States
(12) Patent Application Publication
(10) Pub. No.: US 2026/0080349 A1
(43) Pub. Date: Mar. 19, 2026

(54) Barcode-based four-way shuttle positioning system

(71) Applicant: Bullseye Intelligent Logistics Equipment (Suzhou) Co., Ltd., Suzhou (CN)

(72) Inventors: Xianyi Hong, Suzhou (CN); Libin Kuai, Suzhou (CN); Youcai Shen, Suzhou (CN); Xiangming Wang, Suzhou (CN); Linhua Chen, Suzhou (CN)

(21) Appl. No.: 19/201,709

(22) Filed: May 7, 2025

(30) Foreign Application Priority Data
Sep. 18, 2024 (CN) 202411299013.3

(51) Int. Cl. G06Q 10/08; G05B 13/04; G06K 7/14; G06Q 10/1093

(52) U.S. Cl. CPC G06Q 10/08; G05B 13/048; G06K 7/1413; G06Q 10/1097

(57) ABSTRACT

A barcode-based four-way shuttle positioning system, including a barcode recognition module, a communication module, a control module, an artificial intelligence module, a cloud platform module, a scheduling module, and an auxiliary module. The system automatically and quickly identifies the barcode of the goods, instructs the shuttle to accurately perform the handling task, which greatly reduces the manual intervention and operation time and the error rate. One-dimensional barcode with adhesive glue is affixed to the side of the track where four-way vehicles travel, replacing traditional counting sheets or QR codes.

### FIELD OF THE INVENTION

The invention relates generally to shuttle positioning, and more specifically, it relates to a barcode-based four-way shuttle positioning system.

### DESCRIPTION OF THE RELATED ART

With the rapid development of the modern logistics industry, warehouse automation and intelligence have become key factors in improving logistics efficiency and reducing operating costs. In automated warehouses, the four-way shuttle is an efficient cargo handling equipment, and the accuracy and intelligence level of its positioning system directly affect the overall operating efficiency of the warehouse.

There are two ways to locate the traditional four-way shuttle:

First, based on RFID and counting sheet combination positioning, the RFID module identifies the label on the counting sheet, and the photoelectric switch signal identifies the counting sheet positioning. This positioning method requires writing the RFID tag data on the counting sheet in advance, which is labor-intensive and costly. The photoelectric switch signal positioning accuracy is poor and it is very easy to be mis-sensed, causing the four-way shuttle to fail.

Second, based on QR code positioning, but this positioning method generally places the QR code horizontally on the shelf, and the QR code is prone to dust accumulation, causing the sensor to miss or misread. Manufacturers generally provide a sweeper to regularly clean the QR code dust, which increases customer costs, and multiple sweeps are prone to damage the QR code.

### BRIEF SUMMARY OF THE INVENTION

This invention presents a barcode-based four-way shuttle positioning system designed to optimize warehouse operations. The system comprises several key modules: barcode recognition, communication, control, artificial intelligence, cloud platform, scheduling, and auxiliary components.

The barcode recognition module captures barcode data from the warehouse and transmits it to the control module via the communication module. The control module integrates barcode data, motor encoder readings, and real-time coordinates, transmitting information to the artificial intelligence module, cloud platform, and scheduling module for processing, remote monitoring, and task allocation.

The artificial intelligence module includes data preprocessing, feature engineering, model training, evaluation, deployment, updating, and visualization. It optimizes path planning and task predictions using machine learning algorithms like linear regression, principal component analysis, and information gain for feature selection. Model performance is evaluated with accuracy metrics and updated periodically to maintain relevance.

The cloud platform module enables remote data storage, monitoring, and multi-warehouse collaboration, while the scheduling module optimizes task assignments and shuttle movement. The auxiliary module supports power management, security monitoring, and emergency alerts.

By integrating barcode recognition with artificial intelligence driven optimization and cloud-based management, the system enhances warehouse efficiency, shuttle navigation, and resource utilization.

One object of the invention is to provide a barcode-based four-way shuttle positioning system to enhance vehicle localization in warehouses.

Another object of the invention is to incorporate multiple modules, including barcode recognition, communication, control, artificial intelligence, cloud, scheduling, and auxiliary modules, for efficient operation.

Another object of the invention is for the barcode recognition module to collect barcode data and send it to the control module.

Another object of the invention is for the communication module to transmit data between different system components.

Another object of the invention is for the artificial intelligence module to process real-time coordinates and optimize shuttle paths.

Another object of the invention is for the cloud platform module to enable remote monitoring and management.

Another object of the invention is to use feature engineering and machine learning techniques, such as linear regression and principal component analysis, to improve prediction accuracy.

Another object of the invention is to continuously update models with new data to adapt to changing conditions.

Another object of the invention is for the scheduling module to intelligently plan shuttle movements based on warehouse operations.

Another object of the invention is for the auxiliary module to support power management, safety monitoring, and alarm functions.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in drawings. The invention is capable of other embodiments and of being practiced and carried out in various ways. Also, it is to be understood that the phraseology and terminology employed herein are for the purpose of the description and should not be regarded as limiting.

In this invention, through its high-precision barcode recognition and intelligent scheduling functions, the efficiency and accuracy of warehouse operations are significantly improved. The system can automatically and quickly identify the goods' barcodes and instruct the shuttle to execute handling tasks precisely, greatly reducing manual intervention and operation time, while also lowering the error rate. This enhances the overall smoothness and reliability of warehouse operations. Additionally, barcodes replace traditional counting plates and QR codes as location references. Adhesive-backed one-dimensional barcodes are affixed to the sides of the tracks for the four-way shuttle, replacing counting plates and QR codes. This saves on supports, reduces construction steps, simplifies maintenance, and resolves the issue of misreading caused by photoelectric sensors. It also overcomes the shortcomings of QR codes being prone to dust accumulation, which can lead to misreads or missed reads, thus stabilizing the operation of the four-way shuttle.

The artificial intelligence module learns from a large amount of historical data through machine learning algorithms, enabling it to accurately predict and optimize the shuttle's travel path, significantly improving the efficiency of goods handling within the warehouse. Furthermore, the module can analyze barcode recognition data in real time, automatically identify and correct errors, ensuring the accuracy of goods information and reducing losses caused by human errors. The artificial intelligence module also continuously learns from warehouse operations to optimize scheduling strategies, improving resource utilization and reducing energy consumption. Finally, this module provides intelligent decision support, offering in-depth analysis of operational data to help enterprises identify potential issues and areas for improvement, enabling more refined management and enhancing the overall intelligence of the warehouse logistics system.

To the accomplishment of the above and related advantages, this disclosure may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a diagram of the overall system of the present invention;

FIG. 2 is a diagram of the system in the present invention;

FIG. 3 is a schematic diagram of the position information on the barcode in the present invention.

### DETAILED DESCRIPTION OF THE INVENTION

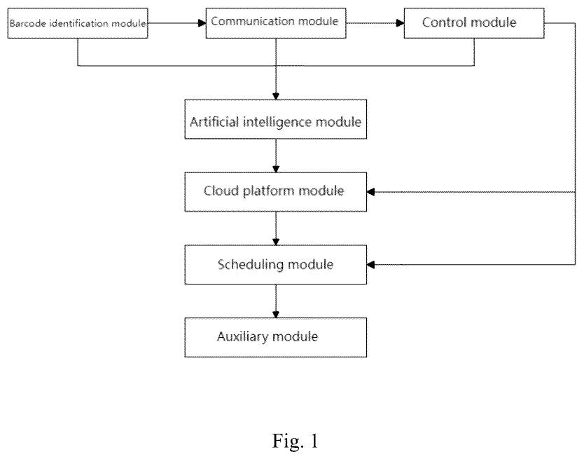

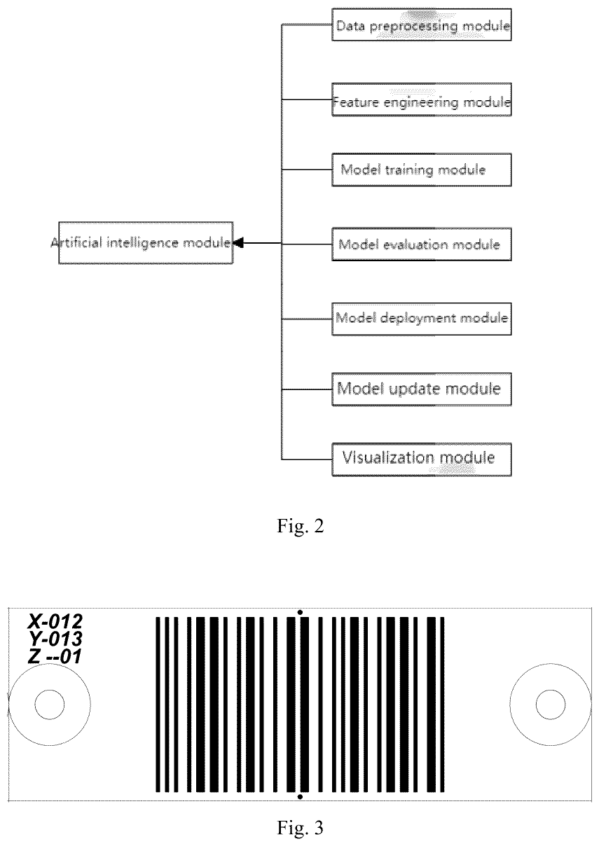

Turning now descriptively to the drawings, in which similar reference characters denote similar elements throughout the several views, FIG. 1 to FIG. 3 illustrate an embodiment of a barcode-based four-way shuttle positioning system, which includes:

A barcode recognition module, a communication module, a control module, an artificial intelligence module, a cloud platform module, a scheduling module and an auxiliary module; the barcode recognition module is connected to the communication module and sends scanned barcode information to the control module; the communication module is connected to the control module and transits barcode information and motor encoder data to the control module; the control module is connected to the artificial intelligence module, sending real-time coordinate data and receiving path optimization and task prediction instructions; the control module is connected to the cloud platform module, sending real-time coordinate data and receiving remote monitoring and management instructions; the control module is connected to the scheduling module, sending real-time coordinate data and receiving task scheduling instructions; the artificial intelligence module is connected to the cloud platform module, sending prediction results to the cloud platform and receiving cloud data for training and learning; the artificial intelligence module consists of a data preprocessing module, a feature engineering module, a model training module, a model evaluation module, a model deployment module, a model update module and a visualization module.

In another embodiment, the data preprocessing module uses standardization to scale coordinate data to a mean of 0 and a standard deviation of 1, with a formula:

$${x}^{′} = ( x - min ) / ( max - min ) ;$$

where x′ is normalized value; x is original value; min is minimum value, and max is maximum value;
the data prepossessing module uses mean imputation to replace missing values and applies linear interpolation to estimate missing coordinate data, with a formula:

$$x = x 0 + ( x 1 - x 0 ) * ( t - t 0 ) / ( t 1 - t 0 ) ;$$

where x is estimated coordinate; x0, x1 are two nearest valid coordinates; t is timestamp corresponding to missing coordinate data; t0, t1 are timestamps corresponding to the two valid coordinates.

In another embodiment, the feature engineering module evaluates information content of features concerning a target variable using information gain and selects a feature with highest information gain, with a formula:

$$IG ( T , A ) = Entropy ( T ) - \sum \vert T\_v \vert / \vert T \vert * Entropy ( T\_v ) ;$$

where IG (T, A) is information gain of feature A to a target variable T; Entropy(T) is entropy of the target variable T; |T_v| is number of samples for feature A with value v; |T| is total number of samples; Entropy(T_v) represents entropy of samples for feature A with value v;
the feature engineering module applies principal component analysis to transform original features into new features using a linear transformation, reducing dimensionality while preserving most information, with a formula:

$$Z = W * X ;$$

where Z is a new feature matrix, W is an orthogonal matrix containing eigenvectors, and X is an original feature matrix.

In another embodiment, the model training module uses a linear regression model for training, following algorithmic steps:
S1: initialize model parameters, setting initial weight w and bias b;
S2: forward propagation, calculating a predicted value y\hat{ } with a formula:

$$y \hat{} ( x ) = w \cdot x + b ;$$

where y\hat{ }(x) is a predicted output for input x; w is a weight vector; x is an input feature vector; b is a bias term;
S3: compute loss function using mean squared error (MSE) with a formula:

$$L ( y , y \hat{} ) = 1 / n \sum {( yi - y \hat{} \_i )}^{2} ;$$

where L(y, y\hat{ }) is a loss function; y is an actual value vector; y\hat{ } is a predicted value vector and n is number of samples;
S4: back propagation, computing gradient of the loss function with respect to model parameters;
Gradient of weight w is:

$$\partial L / \partial w = - 2 / n \sum ( y\_i - y \hat{} \_i ) x\_i ;$$

Gradient of bias b is:

$$\partial L / \partial b = - 2 / n \sum ( y\_i - y \hat{} \_i ) ;$$

S5: update model parameters using gradient descent method:
Updated weight is:

$$w = W - α * \partial L / \partial w ;$$

Updated bias is:

$$b = b - α * \partial L / \partial b ;$$

where a represents a learning rate;
S6: repeat S2-S5 until model converges, convergence criteria are either the loss function falling below a certain threshold or reaching a predefined number of iterations.

In another embodiment, the model evaluation module is a critical component in the artificial intelligence system for measuring model performance and accuracy; it involves testing and validating a trained model to assess its performance on unseen data; evaluation metrics include accuracy, recall, F1-score, and mean squared error, depending on model type and application scenario; the model deployment module is responsible for integrating trained and evaluated a model into real-world environments; it converts a model into a format suitable for production, packages it as an API service, and deploys it on cloud servers or edge devices.

In another embodiment, the model update module ensures that a model remains accurate and relevant over time as data accumulates; it involves periodically retraining a model with new data points and features to adapt to changes in data distribution or concept drift; the visualization module provides an intuitive representation of model performance and data analysis in artificial intelligence systems; it uses charts, dashboards, and interactive interfaces to display model inputs, outputs, performance metrics, and predictions, making it accessible for non-technical users; the visualization module includes data exploration tools, monitoring of model training process, interpretation of prediction results, and visualization of model decision path.

In another embodiment, the barcode recognition module is a front-end perception unit of the four-way shuttle positioning system, responsible for collecting and processing barcode information in warehouses; it includes barcode scanners or camera sensors, along with image recognition and processing software, to identify and extract barcode information from complex warehouse environments and convert it into a usable data format.

In another embodiment, the communication module serves as a bridge for information exchange among different components of the four-way shuttle positioning system; it facilitates data transmission and exchange between the barcode recognition module, the control module and the artificial intelligence module; the control module is an execution unit of the four-way shuttle positioning system, receiving commands from the artificial intelligence module and directly controlling shuttle movement; it includes motion controllers, drivers, and actuators, translating instructions into specific actions such as moving forward, backward, and turning.

In another embodiment, the cloud platform module provides a remote data storage, processing and analysis platform for the four-way shuttle positioning system; it enables data to be uploaded to a cloud for large-scale processing and analysis, while also supporting remote monitoring and fault diagnosis; the cloud platform module also facilitates data sharing and collaboration across multiple warehouses; the auxiliary module serves as a support unit for the four-way shuttle positioning system, including power management, security monitoring, and alarm system functions; the power management module ensures stable power supply under both normal and emergency situations.

In another embodiment, the scheduling module serves as a task distribution center; it intelligently plans movement paths and task sequences of shuttle based on warehouse operational needs, shuttle status, and location information; core algorithms of the scheduling module include path planning, task scheduling, and resource optimization.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims (and their equivalents) in which all terms are meant in their broadest reasonable sense unless otherwise indicated. Any headings utilized within the description are for convenience only and have no legal or limiting effect.

1. A barcode-based four-way shuttle positioning system, comprising a barcode recognition module, a communication module, a control module, an artificial intelligence module, a cloud platform module, a scheduling module and an auxiliary module;
the barcode recognition module is connected to the communication module and sends scanned barcode information to the control module;
the communication module is connected to the control module and transits barcode information and motor encoder data to the control module;
the control module is connected to the artificial intelligence module, sending real-time coordinate data and receiving path optimization and task prediction instructions;
the control module is connected to the cloud platform module, sending real-time coordinate data and receiving remote monitoring and management instructions;
the control module is connected to the scheduling module, sending real-time coordinate data and receiving task scheduling instructions;
the artificial intelligence module is connected to the cloud platform module, sending prediction results to the cloud platform and receiving cloud data for training and learning;
the artificial intelligence module consists of a data preprocessing module, a feature engineering module, a model training module, a model evaluation module, a model deployment module, a model update module and a visualization module.

2. The barcode-based four-way shuttle positioning system in claim 1, wherein the data preprocessing module uses standardization to scale coordinate data to a mean of 0 and a standard deviation of 1, with a formula:
$${x}^{′} = ( x - min ) / ( max - min ) ;$$
where x′ is normalized value; x is original value; min is minimum value, and max is maximum value;
the data prepossessing module uses mean imputation to replace missing values and applies linear interpolation to estimate missing coordinate data, with a formula:
$$x = x 0 + ( x 1 - x 0 ) * ( t - t 0 ) / ( t 1 - t 0 ) ;$$
where x is estimated coordinate; x0, x1 are two nearest valid coordinates; t is timestamp corresponding to missing coordinate data; t0, t1 are timestamps corresponding to the two valid coordinates.

3. The barcode-based four-way shuttle positioning system in claim 1, wherein the feature engineering module evaluates information content of features concerning a target variable using information gain and selects a feature with highest information gain, with a formula:
$$IG ( T , A ) = Entropy ( T ) - \sum \vert T\_v \vert / \vert T \vert * Entropy ( T\_v ) ;$$
where IG (T, A) is information gain of feature A to a target variable T; Entropy(T) is entropy of the target variable T; |T_v| is number of samples for feature A with value v; |T| is total number of samples; Entropy(T_v) represents entropy of samples for feature A with value v;
the feature engineering module applies principal component analysis to transform original features into new features using a linear transformation, reducing dimensionality while preserving most information, with a formula:
$$Z = W * X ;$$
where Z is a new feature matrix, W is an orthogonal matrix containing eigenvectors, and X is an original feature matrix.

4. The barcode-based four-way shuttle positioning system in claim 1, wherein the model training module uses a linear regression model for training, following algorithmic steps:
S1: initialize model parameters, setting initial weight w and bias b;
S2: forward propagation, calculating a predicted value y\hat{ } with a formula:
$$y \hat{} ( x ) = w \cdot x + b ;$$
where y\hat{ }(x) is a predicted output for input x; w is a weight vector; x is an input feature vector; b is a bias term;
S3: compute loss function using mean squared error (MSE) with a formula:
$$L ( y , y \hat{} ) = 1 / n \sum {( yi - y \hat{} \_i )}^{2} ;$$
where L(y, y\hat{ }) is a loss function; y is an actual value vector; y\hat{ } is a predicted value vector and n is number of samples;
S4: back propagation, computing gradient of the loss function with respect to model parameters;
Gradient of weight w is:
$$\partial L / \partial w = - 2 / n \sum ( y\_i - y \hat{} \_i ) x\_i ;$$
Gradient of bias b is:
$$\partial L / \partial b = - 2 / n \sum ( y\_i - y \hat{} \_i ) ;$$
S5: update model parameters using gradient descent method:
Updated weight is:
$$w = W - α * \partial L / \partial w ;$$
Updated bias is:
$$b = b - α * \partial L / \partial b ;$$
where a represents a learning rate;
S6: repeat S2-S5 until model converges, convergence criteria are either the loss function falling below a certain threshold or reaching a predefined number of iterations.

5. The barcode-based four-way shuttle positioning system in claim 1, wherein the model evaluation module is a critical component in the artificial intelligence system for measuring model performance and accuracy; it involves testing and validating a trained model to assess its performance on unseen data; evaluation metrics include accuracy, recall, F1-score, and mean squared error, depending on model type and application scenario; the model deployment module is responsible for integrating trained and evaluated a model into real-world environments; it converts a model into a format suitable for production, packages it as an API service, and deploys it on cloud servers or edge devices.

6. The barcode-based four-way shuttle positioning system in claim 1, wherein the model update module ensures that a model remains accurate and relevant over time as data accumulates; it involves periodically retraining a model with new data points and features to adapt to changes in data distribution or concept drift; the visualization module provides an intuitive representation of model performance and data analysis in artificial intelligence systems; it uses charts, dashboards, and interactive interfaces to display model inputs, outputs, performance metrics, and predictions, making it accessible for non-technical users; the visualization module includes data exploration tools, monitoring of model training process, interpretation of prediction results, and visualization of model decision path.

7. The barcode-based four-way shuttle positioning system in claim 1, wherein the barcode recognition module is a front-end perception unit of the four-way shuttle positioning system, responsible for collecting and processing barcode information in warehouses; it includes barcode scanners or camera sensors, along with image recognition and processing software, to identify and extract barcode information from complex warehouse environments and convert it into a usable data format.

8. The barcode-based four-way shuttle positioning system in claim 1, wherein the communication module serves as a bridge for information exchange among different components of the four-way shuttle positioning system; it facilitates data transmission and exchange between the barcode recognition module, the control module and the artificial intelligence module; the control module is an execution unit of the four-way shuttle positioning system, receiving commands from the artificial intelligence module and directly controlling shuttle movement; it includes motion controllers, drivers, and actuators, translating instructions into specific actions such as moving forward, backward, and turning.

9. The barcode-based four-way shuttle positioning system in claim 1, wherein the cloud platform module provides a remote data storage, processing and analysis platform for the four-way shuttle positioning system; it enables data to be uploaded to a cloud for large-scale processing and analysis, while also supporting remote monitoring and fault diagnosis; the cloud platform module also facilitates data sharing and collaboration across multiple warehouses; the auxiliary module serves as a support unit for the four-way shuttle positioning system, including power management, security monitoring, and alarm system functions; the power management module ensures stable power supply under both normal and emergency situations.

10. The barcode-based four-way shuttle positioning system in claim 1, wherein the scheduling module serves as a task distribution center; it intelligently plans movement paths and task sequences of shuttle based on warehouse operational needs, shuttle status, and location information; core algorithms of the scheduling module include path planning, task scheduling, and resource optimization.
